(19) United States
(12) Patent Application Publication
(10) Pub. No.: US 2006/0059058 A1
(43) Pub. Date: Mar. 16, 2006

(54) System, method , and tool for comparing defined contribution lineups

(76) Inventors: John V. Sturiale, Massillon, OH (US); Ryan S. Horn, Cleveland Heights, OH (US)

Correspondence Address: FOLEY & LARDNER LLP, 150 EAST GILMAN STREET, P.O. BOX 1497, MADISON, WI, 53701-1497, US

(21) Appl. No.: 10/939,120

(22) Filed: Sep. 10, 2004

(51) Int. Cl. G06Q 40/00

(52) U.S. Cl. 705/35

(57) ABSTRACT

The techniques described include determining a first and a second diversification measure of a plurality of funds in a first and a second defined contribution lineup, respectively, determining a first and a second risk factor for the plurality of finds in the first and the second defined contribution lineup, respectively, determining a first and a second consistency of return factor for the plurality of fimds in the first and the second defined contribution lineup, respectively, calculating a first investment menu strength using the first diversification measure, the first risk factor, and the first consistency of return factor, calculating a second investment menu strength using the second diversification measure, the second risk factor, and the second consistency of return factor, and comparing the first defined contribution lineup with the second defined contribution lineup using the first investment menu strength and the second investment menu strength.

### BACKGROUND OF THE INVENTION

1. Field of the Invention

The present invention relates generally to the management of defined contribution lineups. More particularly, the present invention relates to systems, methods, and tools for comparing defined contribution lineups.

2. Description of the Related Art

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

Defined benefit plans, or pensions, are used for an employer to promise to give a retiree a benefit—such as income—upon or during retirement. Defined benefit plans are advantageous in that taxes are not paid on contributions to the plan until withdrawals begin and any interest, dividends, or capital gains that accumulate in the plan are also tax-deferred until withdrawal.

Defined contribution plans are different than defined benefit plans. In a defined contribution plan, the employee knows what is placed into the plan, but does not know what it will be worth upon retirement. Defined benefit plans are the opposite. Defined benefit plans know the result but not what needs to be contributed. There are many advisors, consultants, and others that have spent much time and effort developing tools to find the most efficient portfolio for a Defined Benefit Plan or Managed Account. However, such tools have not been developed for defined contribution plans to analyze the plan's investment lineup from a holistic standpoint.

The most widely used defined contribution plan is the 401(k) plan—which is so—named by the tax code section that created it. There are generally four contribution methods for 401(k) plans. The first method is the employer's basic contribution, which is usually a percentage of payroll. For example, if an employee makes $40,000 a year and his company contributes 1% of his pay to the 401(k) plan every year the basic contribution will be $400. Although the money is the employee's, the employee is not taxed on it, and the money grows tax-deferred inside the plan.

The second method is the employee's voluntary contribution in which the taxpayer may be permitted to contribute up to 15% of pay. The employee gets a tax deduction for the amount he contributes, and like the employer's contribution above, this money grows tax-deferred. The third method is the employer's matching contributions in which the company contributes a percentage of what the employee contributes. For example, a company can add 25 cents to the plan for every dollar that an employee puts in himself. This increases the employee's stake by 25%, yet he is not taxed on this money, and it too grows tax-deferred until he retires.

The fourth method is the employer's profit-sharing contribution which is an additional contribution that the company voluntarily makes each year based on the firm's profits. For example, a company can give an employee a bonus equal to 3% of his pay, which is deposited into the plan on the employee's behalf. Like the other contributions, this contribution is not taxed and grows tax-deferred.

It is the plan sponsor and investment committee member's fiduciary duty to assemble the most diversified palette of funds from which the participants make their investment selection. The plan sponsor cannot control how plan participants will allocate their money. However, the more diversified the palette from which to choose, the better the output results will be.

It could be said that the strategy used by some plan sponsors and investment committee members in assembling 401(k) portfolios is flawed. Often they seek diversification by filling Morningstar-style boxes or offering the major equity asset classes (small, mid, and large). However, many funds-especially in the Momingstar-blend categories-have such a high correlation that they bring little diversification to the plan. Further, a high weighting is placed on looking at every fund in isolation by examining the fund's risk, return, etc versus a benchmark and a category average. Although it is important to understand the manager's performance and to strive to pick managers with good long track records, it is of equal importance to determine how each one of those managers work in combination with one another. It is crucial to make sure that there is diversification in the lineup when participants look to create an ideal asset allocation.

From a fiduciary standpoint, it can be advantageous for a plan sponsor and investment committees to be able to show quantitatively why the defined contribution lineup they chose for their participants was put in place, or why Manager A was used instead of Manager B. Just saying that a manager had good performance or that the committee attempted to fill the style boxes may not be enough.

There is a need for a tool that can show plan sponsors and investment committee members that they have assembled the best and most diversified lineup. There is a need to combine correlation, risk, and consistency of returns of all the funds in the lineup to assess the quality of a defined contribution plan lineup. There is a need to provide a quantitative assessment of the quality of defined contribution lineups.

### SUMMARY OF THE INVENTION

In general, the invention relates to a method of comparing a plurality of defined contribution lineups to quantitatively select a best defined contribution lineup. The method includes, but is not limited to, determining a first diversification measure of a plurality of funds in a first defined contribution lineup, determining a second diversification measure of a plurality of funds in a second defined contribution lineup, and comparing the first defined contribution lineup with the second defined contribution lineup using the first diversification measure and the second diversification measure to select a defined contribution lineup.

Another exemplary embodiment relates to a computer program product for comparing a plurality of defined contribution lineups to allow quantitative selection of a best defined contribution lineup. The computer program product includes, but is not limited to, computer code configured to determine a first diversification measure of a plurality of funds in a first defined contribution lineup, to determine a second diversification measure of a plurality of funds in a second defined contribution lineup, and to display the first diversification measure and the second diversification measure to allow a user to select a defined contribution lineup.

Another exemplary embodiment relates to a system for comparing a plurality of defined contribution lineups to allow quantitative selection of a best defined contribution lineup. The system includes, but is not limited to, a defined contribution calculator, a memory, and a processor. The defmed contribution calculator includes, but is not limited to, computer code configured to determine a first diversification measure of a plurality of funds in a first defined contribution lineup, to determine a second diversification measure of a plurality of funds in a second defined contribution lineup, and to display the first diversification measure and the second diversification measure to allow a user to select a defined contribution lineup. The memory stores the defined contribution calculator. The processor couples to the memory and is configured to execute the defined contribution calculator.

### BRIEF DESCRIPTION OF DRAWINGS

FIG. 1 is a block diagram of a defined contribution lineup mechanism according to an exemplary embodiment.

FIG. 2 is a table with correlations for example Funds A, B, and C.

FIG. 3 is a general diagram of a computer system that analyzes defined contribution lineups.

### DETAILED DESCRIPTION OF EXEMPLARY EMBODIMENTS

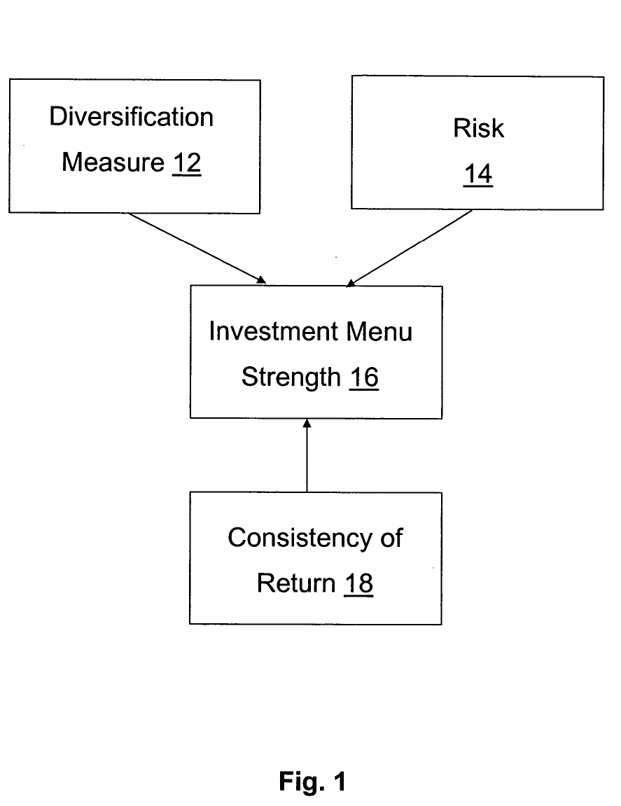

FIG. 1 illustrates a block diagram of a defined contribution lineup mechanism according to an exemplary embodiment. The defined contribution lineup mechanism can determine an investment menu strength factor 16 to facilitate the assembly of defined contribution lineups. FIG. 1 indicates that the investment menu strength factor 16 can be determined using a diversification measure 12, a risk factor 14, and a consistency of return factor 18 as inputs.

The diversification measure 12 can be a cross correlation of all fuids in a portfolio combined. The diversification measure 12 can be referred to as a portfolio diversification measure (PDM). The PDM measures the diversification of the funds in the lineup, preferably not as a one to one correlation (bi-variable), but rather a multiple variable or cross correlation of all the funds in the lineup. The larger the PDM value, the more diversified the funds are in the lineup. Preferably, all fuids in the lineup are equally weighted to provide the best palette for the plan participants.

By way of an example, if there are ten funds in a portfolio, the PDM measures the correlation of all ten funds combined. In an exemplary implementation, the PDM can provide useful information on the marginal correlation of a portfolio when a portfolio manager is replaced. For example, PDM can provide a quantitative measure when an advisor has identified four international managers but does not know which one is best to place in the lineup. The advisor can continue to substitute managers into the portfolio until the marginal correlation is the lowest or the PDM is highest. The PDM's calculation is (1−average correlation of all funds/2)×100.

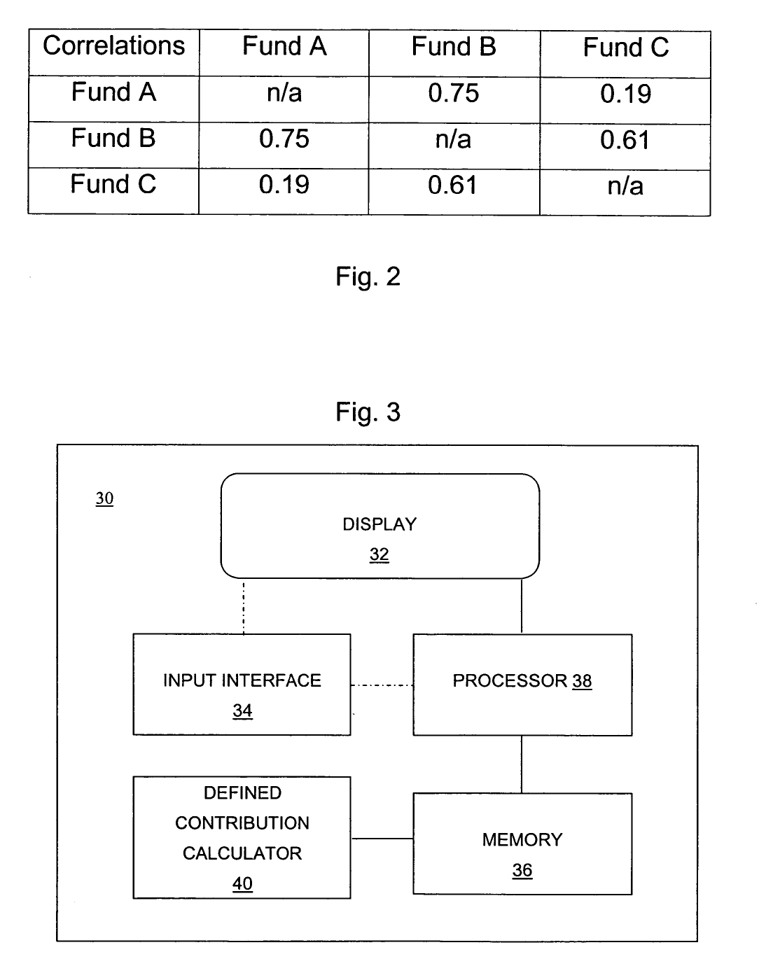

FIG. 2 illustrates a table with example correlations for Funds A, B, and C. An average correlation of Funds A, B, and C is 0.52. As such, PDM=((1-0.52)/2)×100=24. The determined PDM is compared to a universe of all possible combinations of several indexes that could represent possible lineups for a defined contribution plan to determine the quartile ranking and ultimately the level of diversification. The PDM can be calculated for one, three, and five year periods.

Referring again to FIG. 1, the risk factor 14 can be a standard deviation of risk associated with funds in the portfolio. The standard deviation or dispersion from the fund's mean return can be used as a measure of risk. Each fund's standard deviation is calculated and then averaged to determine the risk of the portfolio.

By way of example, assuming the risks for Funds A, B, and C are 15.63, 8.6, and 4.15, respectively, the average Standard Deviation of the funds in the portfolio is 9.46. The risk factor 14 can also be compared to a universe of all possible combinations of several indexes that could represent possible lineups for a defined contribution plan to determine the quartile ranking and ultimately the level of risk. The standard deviation can be calculated for one, three, and five year periods.

The diversification measure 12 and the risk factor 14 can be used in combination to provide a measure of the diversification per unit of risk. Such a measurement—the PDM/Risk—is the PDM divided by the standard deviation. The more diversified and lower the standard deviation of all the funds in the lineup, the higher this number will be.

The consistency of return factor 18 is a measurement of the frequency and magnitude of the fund's performance. The consistency of return factor 18 is increased when a fund outperforms a specific benchmark. In an example implementation, the consistency of return factor 18 is calculated on a five year basis. The consistency of return factor 18 can be calculated as follows:
(Number of years fund outperforms benchmark/Number of years analyzed)+(Cumulative performance of fund/Cumulative performance of benchmark)−1

The average consistency of return factor 18 averages all fund's consistency of return factor 18 to get an average consistency of outperformance of all the funds combined in the portfolio.

As a result, the investment menu strength 16 considers diversification, risk, and performance. The investment menu strength 16 can be formulated as:
Investment Menu Strength=(PDM/Risk)+Return Consistency

A person of skill will understand that—based on the above formulation of the investment menu strength 16—the correlation and risk of the portfolio will mean more to the outcome than how consistent the fund's performance has been.

Advantages of the mechanism described are many. The mechanism quantitatively measures how each Defined Contribution Investment lineup compares with others from a diversification, return, and risk standpoint. Fiduciaries have a responsibility to choose the best and most diversified lineup for their participants to make their choices. The mechanism described helps sponsor and investment committees get closer to the most prudent decision and gives them both factual and analytical proof on why investments were chosen for the plan. It is then up to the participant to take those investments and diversify for their own situation.

Use of the mechanism has shown that a high quality lineup with a high Investment Menu Strength can be assembled with approximately nine funds. Further, the presence of large blend, mid blend, and, small blend (or any combination of these) lowers the PDM as the blend categories are highly correlated. In another example, the PDM and, thus, the Investment Menu Strength are higher by choosing growth funds with a deep growth bias and value funds with a deep value bias. The mechanism can provide other information that is helpful in assembling defined contribution lineups.

An example set of results may be a PDM of 36, a risk factor of 9, and a consistency of return of 2 that results in an average investment menu strength of 6 (36/9+2). The PDM and standard deviation calculated for a portfolio can be compared to a universe of all possible portfolio combinations of two or more asset classes. Thus, a PDM and a standard deviation can be calculated for a universe of possible portfolio combinations to rank each individual portfolio within the universe for comparison.

The PDM and standard deviation universe are derived by identifying all possible unique index portfolio combinations from a chosen list of two or more indexes. For example, if four indexes (Index A, B, C, D) are chosen to create the universe, there are eleven possible unique index portfolio combinations. A distinct order does not make a combination unique. Thus, the combination AB is not unique relative to the combination BA. Therefore, the unique index portfolio combinations given four indexes A, B, C, and D comprise: AB, ABC, ABCD, AC, ABD, AD, ACD, BC, BCD, BD, and CD. A PDM and a standard deviation may be calculated for each unique index portfolio combination. The calculated results may be sorted and used as the PDM and standard deviation universe against which client portfolios are compared.

FIG. 3 illustrates a computer system configured to analyze defined contribution lineups. In an exemplary embodiment, the device 30 may include, but is not limited to, a display 32, an input interface 34, a memory 36 a processor 38, and a defined contribution calculator 40. The display 32 presents information to a user of the device 30. The display 32 may be, but is not limited to, a thin film transistor (TFT) display, a light emitting diode (LED) display, a Liquid Crystal Display (LCD), a Cathode Ray Tube (CRT) display, etc.

The input interface 34 provides an interface for receiving information from the user for entry into the device 30. The input interface 34 may use various input technologies including, but not limited to, a keyboard, a pen and touch screen, a mouse, a track ball, a touch screen, a keypad, one or more buttons, etc. to allow the user to enter information into the device 30 or to make selections. The input interface 34 may provide both an input and output interface. For example, a touch screen both allows user input and presents output to the user.

The memory 36 may be the electronic holding place for the operating system of the device 30, the defined contribution calculator 40, and/or other applications and data so that the information can be reached quickly by the processor 38. The device 30 may have one or more memory 36 using different memory technologies including, but not limited to, Random Access Memory (RAM), Read Only Memory (ROM), flash memory, etc.

The processor 38 may retrieve a set of instructions from a non-volatile or a permanent memory and copy the instructions in an executable form to a temporary memory. The processor 38 executes an application or a utility, meaning that it performs the operations called for by that instruction set. The processor 38 may be implemented as a special purpose computer, logic circuits, hardware circuits, etc. Thus, the processor 38 may be implemented in hardware, firmware, software, or any combination of these methods. The device 30 may have one or more processor 38.

The defined contribution calculator 40 is an organized set of instructions that, when executed, cause the device 30 to perform some or all of the calculations described with reference to the investment menu strength factor 16 including, but not limited to, calculating the diversification measure 12, the risk factor 14, and/or the consistency of return factor 18. The instructions may be written using one or more programming languages, assembly languages, scripting languages, etc. In an exemplary embodiment, the defined contribution calculator 40 may be implemented in a spreadsheet application such as Microsoft Excel®. The display 32 may display one or more of the diversification measure 12, the risk factor 14, the consistency of return factor 18, and/or the investment menu strength factor 16 to a user of the device 30 to allow the user to select a best defined contribution lineup.

While several embodiments of the invention have been described, it is to be understood that modifications and changes will occur to those skilled in the art to which the invention pertains. For example, although one particular formula is used as an example, the system is not limited to any specific formulation. Accordingly, the claims appended to this specification are intended to define the invention precisely.

1. A method of comparing a plurality of defined contribution lineups to quantitatively select a best defined contribution lineup, the method comprising:
determining a first diversification measure of a plurality of funds in a first defined contribution lineup;
determining a second diversification measure of a plurality of funds in a second defined contribution lineup; and
comparing the first defined contribution lineup with the second defined contribution lineup using the first diversification measure and the second diversification measure to select a defined contribution lineup.

2. The method of claim 1, wherein determining the first diversification measure comprises calculating a cross correlation for each fund pair, wherein each fund pair includes a first entry selected from the plurality of funds in the first defined contribution lineup and a second entry selected from the plurality of funds in the first defined contribution lineup excluding the first entry.

3. The method of claim 2, wherein determining the first diversification measure further comprises calculating an average cross correlation for the plurality of funds in the first defined contribution lineup using the cross correlation for each fund pair.

4. The method of claim 3, wherein determining the first diversification measure comprises calculating a portfolio diversification measure for the plurality of funds in the first defined contribution lineup using the average cross correlation.

5. The method of claim 1, further comprising:
determining a first risk factor for the plurality of funds in the first defined contribution lineup;
calculating a first diversification per unit risk using the first diversification measure and the first risk factor;
determining a second risk factor for the plurality of funds in the second defined contribution lineup; and
calculating a second diversification per unit risk using the second diversification measure and the second risk factor;
wherein comparing the first defined contribution lineup with the second defined contribution lineup further comprises using the first diversification per unit risk and the second diversification per unit risk.

6. The method of claim 5, wherein determining the first risk factor comprises calculating a standard deviation of risk for each find of the plurality of funds in the first defined contribution lineup.

7. The method of claim 6, wherein determining the first risk factor further comprises calculating an average standard deviation of risk for the plurality of funds in the first defmed contribution lineup using the standard deviation of risk for each fund.

8. The method of claim 6, wherein the standard deviation of risk for each fund is the deviation from a mean return of each fund.

9. The method of claim 5, further comprising:
determining a first consistency of return factor for the plurality of funds in the first defined contribution lineup;
calculating a first investment menu strength using the first diversification measure, the first risk factor, and the first consistency of return factor;
determining a second consistency of return factor for the plurality of funds in the second defined contribution lineup; and
calculating a second investment menu strength using the second diversification measure, the second risk factor, and the second consistency of return factor;
wherein comparing the first defined contribution lineup with the second defined contribution lineup further comprises using the first investment menu strength and the second investment menu strength.

10. The method of claim 9, wherein determining the first consistency of return factor comprises calculating a number of years each fund of the plurality of funds in the first defined contribution lineup outperforms a benchmark.

11. The method of claim 9, wherein determining the first consistency of return factor comprises calculating a cumulative performance for each fund of the plurality of funds in the first defined contribution lineup.

12. The method of claim 11, wherein determining the first consistency of return factor comprises calculating a cumulative performance of a benchmark for each fund of the plurality of funds in the first defined contribution lineup.

13. A computer program product for comparing a plurality of defined contribution lineups to allow quantitative selection of a best defined contribution lineup, the computer program product comprising:
computer code configured to
determine a first diversification measure of a plurality of funds in a first defined contribution lineup;
determine a second diversification measure of a plurality of funds in a second defined contribution lineup; and
display the first diversification measure and the second diversification measure to allow a user to select a defined contribution lineup.

14. The computer program product of claim 13, wherein the computer code configured to determine the first diversification measure comprises computer code configured to calculate a cross correlation for each fund pair, wherein each fund pair includes a first entry selected from the plurality of funds in the first defined contribution lineup and a second entry selected from the plurality of funds in the first defined contribution lineup excluding the first entry.

15. The computer program product of claim 14, wherein the computer code configured to determine the first diversification measure further comprises computer code configured to calculate an average cross correlation for the plurality of funds in the first defined contribution lineup using the cross correlation for each fund pair.

16. The computer program product of claim 15, wherein the computer code configured to determine the first diversification measure further comprises computer code configured to calculate a portfolio diversification measure for the plurality of funds in the first defined contribution lineup using the average cross correlation.

17. The computer program product of claim 13, further comprising computer code configured to:
determine a first risk factor for the plurality of funds in the first defined contribution lineup;
calculate a first diversification per unit risk using the first diversification measure and the first risk factor;
determine a second risk factor for the plurality of funds in the second defined contribution lineup;
calculate a second diversification per unit risk using the second diversification measure and the second risk factor; and
display the first diversification per unit risk and the second diversification per unit risk to allow the user to select the defined contribution lineup.

18. The computer program product of claim 17, wherein the computer code configured to determine the first risk factor comprises computer code configured to calculate a standard deviation of risk for each fund of the plurality of funds in the first defined contribution lineup.

19. The computer program product of claim 18, wherein the computer code configured to determine the first risk factor further comprises computer code configured to calculate an average standard deviation of risk for the plurality of funds in the first defined contribution lineup using the standard deviation of risk for each fund.

20. The computer program product of claim 18, wherein the standard deviation of risk for each fund is the deviation from a mean return of each fund.

21. The computer program product of claim 17, further comprising computer code configured to:
determine a first consistency of return factor for the plurality of funds in the first defined contribution lineup;
calculate a first investment menu strength using the first diversification measure, the first risk factor, and the first consistency of return factor;
determine a second consistency of return factor for the plurality of funds in the second defined contribution lineup;
calculate a second investment menu strength using the second diversification measure, the second risk factor, and the second consistency of return factor; and
display the first investment menu strength and the second investment menu strength to allow the user to select the defined contribution lineup.

22. The computer program product of claim 21, wherein the computer code configured to determine the first consistency of return factor comprises computer code configured to calculate a number of years each fund of the plurality of funds in the first defined contribution lineup outperforms a benchmark.

23. The computer program product of claim 21, wherein the computer code configured to determine the first consistency of return factor comprises computer code configured to calculate a cumulative performance for each fund of the plurality of funds in the first defined contribution lineup.

24. The computer program product of claim 23, wherein the computer code configured to determine the first consistency of return factor further comprises computer code configured to calculate a cumulative performance of a benchmark for each fund of the plurality of funds in the first defined contribution lineup.

25. A system for comparing a plurality of defined contribution lineups to allow quantitative selection of a best defined contribution lineup, the system comprising:
a defined contribution calculator, the defined contribution calculator comprising computer code configured to
determine a first diversification measure of a plurality of funds in a first defined contribution lineup;
determine a second diversification measure of a plurality of funds in a second defined contribution lineup; and
display the first diversification measure and the second diversification measure to allow a user to select a defined contribution lineup;
a memory, wherein the memory stores the defined contribution calculator; and
a processor coupled to the memory, the processor configured to execute the defined contribution calculator.
